(19) United States
(12) Patent Application Publication
(10) Pub. No.: US 2005/0107492 A1
(43) Pub. Date: May 19, 2005

(54) Opaque ink coloring compositions

(75) Inventor: Chhman Sukhna, Floral Park, NY (US)

Correspondence Address: OSTROLENK FABER GERB & SOFFEN, 1180 AVENUE OF THE AMERICAS, NEW YORK, NY, 100368403, US

(73) Assignee: Dri Mark Products, Inc.

(21) Appl. No.: 10/717,067

(22) Filed: Nov. 19, 2003

(51) Int. Cl. C03C 17/00; C09D 11/00

(52) U.S. Cl. 523/160; 523/161

(57) ABSTRACT

A water-based opaque ink coloring composition is disclosed that is suitable for use in markers and which contains a carrier comprising water, a dimethicone copolyol, and submicron polymeric particles having an outer polymeric shell which defines an inner hollow region, but does not contain a neutral buoyancy additive.

### FIELD OF THE INVENTION

The invention relates to the field of water-based opaque ink coloring compositions for drawing and coloring purposes. Water-based coloring compositions are provided which produce vivid images on a wide variety of writing surfaces.

### DESCRIPTION OF THE RELATED ART

From the invention of chalk, to write on chalkboards, there has been always a need to create inks to write on all dark surfaces, even though these types of ink will also write on light surfaces. White and/or opaque inks have always been difficult to achieve because the common opacifiers titanium dioxide, clays, talcs, etc., have very high specific gravities and therefore rapidly settle causing clogging and poor shelf life in the writing instrument. A valve action marker combats this problem by having a ball that agitates the ink on shaking thereby creating a homogeneous system which can write uniformly.

The present invention does not utilize a valve-action system but a more simple marker which has a filler made of either acetate, polyester, or some other form of fiber that provides absorption and release by capillary action. This filler, or sponge like/tampon like component, is in contact with the writing tip which dispenses the ink onto the surface. The present invention has a composition that remains uniform to provide a long shelf life and to prevent clogging at the writing tip or nib. This composition does not utilize any of the common opacifiers listed above. But a rather novel ingredient described as a hollow microsphere. This product was originally developed as a cost-saving substitute for titanium dioxide as described in U.S. Pat. No. 4,885,320.

U.S. Pat. No. 4,880,465 to Loria utilizes this ingredient, or a form of it, to make inks for an ink jet system, which has its own unique method of delivery.

U.S. Pat. Nos. 6,174,938 and 5,968,241 describe ink systems for capillary action markers, but they utilize additional important ingredients so called a “Neutral Buoyancy Additive” to help combat settling in their markers.

U.S. Pat. Nos. 6,451,099 and 6,492,435 to Miyaoto utilize hollow microspheres, but these inks are specifically for ballpoint pens whose method of operation is totally different from capillary markers or free ink system markers.

The present invention relates to a new and novel approach to maintain a stable and economical, viable writing instrument. The present invention's ink system by its mere simplicity in the quantity and type of ingredients allows the said ingredients to bond cohesively so as to maintain a homogeneous non-settling ink that provides a long shelf life in the marker.

This ink system can be formulated as the examples illustrate to provide a white and/or colored writing inks as desired. Upon drying it will provide vivid, unbroken lines on both light, dark, or colored surfaces. These may include, but are not limited to, paper, board, glass, cardboard, poster board, and an assorted varieties of dry erase/wet erase boards. The many uses of this composition include, but are not limited to writing, coloring, dry erase, wet erase, and poster work, etc.

### SUMMARY OF THE INVENTION

The present invention provides a water-based opaque ink coloring composition suitable for use in markers comprising:
(a) a carrier comprising water;
(b) a dimethicone copolyol; and
(c) submicron polymeric particles having an outer polymeric shell which defines an inner hollow region,
wherein said composition does not contain a neutral buoyancy additive.

The present invention also provides a marking instrument for applying an opaque ink coloring composition comprising a nib and a reservoir wherein said reservoir contains a water-based opaque ink coloring composition comprising:
(a) a carrier comprising water;
(b) a dimethicone copolyol; and
(c) submicron polymeric particles having an outer polymeric shell which defines an inner hollow region,
wherein said composition does not contain a neutral buoyancy additive.

### DETAILED DESCRIPTION OF THE PREFERRED EMBODIMENTS OF INVENTION

In utilizing the term “invention” below, the aim is to describe preferred embodiments or describe possible effects or theories of operation, and not in any way to limit the scope of the claims which follow the detailed description.

The general object of this invention is to provide an opaque ink composition that works reliably in a wick or capillary action type writing instrument. This ink will also work well in a filler-type as well as free ink system which does not contain a filler since it remains homogeneous and there is no settling. In wet inks, the beads are filled with water, as the ink dries when written on a surface, the water diffuses and evaporates, the space created is replaced by air which forms discrete air voids that scatter light, thereby creating an opaque effect.

One of the inherent aims of this composition is to provide a white ink which will remain white and opaque on all surfaces when dried. By incorporating color in the forms of dyes and/or pigments, we can create a colored opaque writing ink also.

An unusual property of this ink is on initial writing, the mark seems also invisible, but then appears opaque and vivid after a few seconds and as the water evaporates from its surface. Another aim is to create a dry erase/wet erase writing ink.

The forgoing and other objects of the invention are realized by careful choice and use of ingredients that eliminates settling and separation of the ink system and provide a cost-effective capillary type writing instrument which will provide the consumer with long shelf life and effective use.

This invention can be utilized as both a writing or coloring tool depending on the desire of the consumer.

This coloring composition of the present invention is preferably is a one-phase ink with a pH from about 6 to about 10, preferably from about 7.9 to about 8.5 having a viscosity on a Brookfield viscometer of about 1 to about 20, preferably from about 5.0 to about 10.0 centipoise at 70° F. This ink is suitable for use in a wick-style or free-ink writing instrument.

The coloring composition of the present invention contains hollow microspheres preferably in the form of styrene/acrylic emulsion which upon drying contains air that scatters light thereby creating the opaque or non-see thru effect. These types of products are commonly called opacifiers and are available commercially from Rohn and Haas as Ropaque t.m OP-96, HP-1055, and Ropaque t.m Ultra. Nippon Zeon Company also produces a similar product, t.m MN-5055, but in long term testing the Ropaque products are superior. The scattering of light provides opacity or whiteness thought to come from differences in the refractive index of the resin layer and the void inside, hence the scattering described above.

The submicron polymeric particles may be made of virtually any organic polymer and may be either thermoplastic or thermosetting. Useful thermoplastic resins for forming microspheres include cellulose derivatives, acrylic resins, polyolefins, polyamides, polycarbonates, polystyrene, copolymers of styrene and other vinyl monomers, vinyl polymers such as homo- or copolymers of vinyl acetate, vinyl alcohol, vinyl chloride, vinyl butyral, and homo- and copolymers of dienes. Particularly useful are copolymers of styrene and other vinyl monomers. Acrylic-styrene copolymers are most preferred. The polymeric particles may also comprise suitable thermosetting resins including hydroxyl esters of ethylenically-unsaturated monomers which are typically admixed with a crosslinking agent or admixtures of alkyl resins which may be employed with cross-linking agents.

Useful submicron polymeric particles may be modified with traditional dyes, pigments, or other materials to provide a coloring composition that exhibits a unique appearance (e.g., fluorescent, opalescent, metallic, etc.). For example, dyes can be incorporated into the submicron polymeric particles during the manufacture of such polymeric particles. Examples of modified polymeric particles include fluorescent pigments marketed by Day-Glo Color Corporation under the tradenames Splash Colors™ SPL-N and Echo Colors™ ECX. Both Day-Glo™ SPL-N and Day-Glo™ ECX fluorescent pigment particles are supplied as dispersions having a specific gravity of about 1.0-1.1. Day-Glo™ SPL-N dispersions are supplied as 46-50% solids with a particle size range of 0.25-0.40 microns. Day-Glo™ ECX dispersions are supplied as 42-46% solids with a particle size range of less than 0.20 microns. Modified submicron polymeric particles may be mixed with other submicron polymeric particles, such as microspheres, to produce coloring compositions that produce unique images.

The submicron polymeric particles are used at a quantity of about 5% to about 80%, more preferably about 35% to about 80%, and most preferably about 50% to about 60% by weight. The preferred quantity is about 75% by weight for a white ink.

This coloring system has water as a carrier preferably deionized water in a percentage of about 3% to about 50%, preferably from about 7.0% to 30%, more preferably of about 9% to about 15% by weight.

The coloring composition of the present invention may include a humectant, preferably from the glycol family namely propylene glycol, diethylene glycol, polyethlene glycol, and glycerin in an amount of about 5% to about 50%, preferably about 10% to about 20% and more preferably about 12% to about 15%. The choice of humectant has an effect on the shelf life of the finished product and therefore careful selection after testing is required. The polyglycols preferred here show they will keep the writing instruments from drying out and sustain heating conditions of 120° F. Other humectants will also work for functionality.

A surfactant to lower surface tension and promote flow may also be added to the ink composition of the present invention. These may be in the form of anionic or non-ionic fluorocarbons. Tergitol 15-S-7 from Union Carbide the triton family from the same company are examples. The Zonyl surfactants from DuPont chemicals are preferred since they not only lower surface tension, but seem to help stabilize the ink system. Other surfactants can provide similar benefits, but may not provide stability to the system.

A permanent polymer may be included if so desired to make the ink permanent on selected surfaces. Acrylic polymers from the BF Goodrich Company, have shown to be useful. These are from the Carboset line of products. Urethane polymers such as the Neorez from ICI Resins are also useful. These polymers will typically have properties of solids 30% to 45%, pH 8.0 to 8.8, Acid No. 40 to 50, minimum film forming temperature of 18° C. to 40° C., and viscosity of 50 to 200 centipoise. These are used at about 5% to about 20%, preferably at about 10% to about 15% by weight range.

The coloring compositions may also contain a pH adjustor preferably in the forms of amines. Triethanolamine is the preferred ingredient, since the odor is faint and volatility is stable.

Preservatives such as Proxel GXL from Avecia Biosides are also useful to prevent the growth of mold and fungi.

Dimethicone copolymers with chemical formulas similar to the Formula I are employed for a variety of uses. [image]
wherein each of x, m and n is an integer from 1 to 500, preferably from 10 to 250, more preferably from 15 to 50. The most preferred dimethicone copolymers are DC-190 and DC-193 (from Dow Corning).

These silicone copolymers have been shown to impart unusual shelf life to the finished ink and marker product. They are theorized to form a chemical bond with the hollow microspheres similar to a spider's web suspending and supporting these microspheres thereby keeping them in a homogeneous solution and preventing them from settling out.

Interestingly, the silicone copolymers have also been found to keep the tips of the markers drying out rapidly. These ingredients are recommended by their manufacturer for a variety of uses, including humectancy, surface tension depressant, lubricating, detackification among others. They are mostly used in cosmetic type products, but we have found a novel way of using them here. Examples of such ingredients are DC190 and DC193 from Dow Corning. From our Spider Web's theory, we believe an additional property has been discovered to add to the many uses of these products.

Others knowledgeable in the art will find similar ingredients to perform a variety of these tasks with varying success in stability and usefulness. One of the many uses of these ingredients is to provide release from surfaces, this is especially important in one of the recommended uses of the invention as a dry erase/wet erase type product for writing on different non-porous boards. The detackification property allows the ink to form a barrier between the ink and the board thereby preventing any long-term adhesion and aiding in easy removal. These ingredients are used at about 1% to about 5%, preferably about 1.75 to about 3.0% and most preferably at about 2.5% by weight. Increasing this amount detracts from the other properties of the ink. These ingredients have a viscosity of 465 to 1500 centipoises at 77° F. and specific gravity of 1.035 to 1.07.

Other forms of silicones such as DC290 Release by Dow Corning, HV490, and Silwet L77 form OSI Specialties provide similar release properties, but do not provide all of the aforementioned other benefits and therefore detract from the homogeneity of the finished ink. Surfactants such as Polysorbate 20 and Polysorbate 80 also function similarly, but again, detract from the long term shelf life and the practical usefulness of the writing instrument.

The coloring compositions of the present invention has a density of about 8.0 lbs/gal to about 9.0 lbs/gal and a viscosity of from about 1 to about 20 centipoises. It can further comprising a colorant, preferably selected from the group consisting of dyes, pigments, and mixtures thereof.

One of the main aims of this invention is to provide a white ink, this can be achieved by using the above ingredients without colors. To complete a pallet of colors, however, a variety of pigments and/or dyes may be needed depending on the end use.

Pigments are preferred to dyes for dry erase and wet erase applications since they do not adsorb on to the surface, however, dyes can also be used even though erasibility may be a problem. The dyes, however, have an advantage of being washable, which is preferred when the product is marketed to children.

Pigments in the form of ready-made dispersions which are user-friendly are preferred. These are commercially available through Sun Chemical in the Sunsperse Series and Flexiverse Series. Mikuni Color Works as the Titicaca Series. They are used at the range of 0.5% to about 30%, preferably about 8% to 15% and most preferably about t 10% by weight.

The dyes utilized can either be acidic, basic, or direct dyes among others. Acid dyes are mostly used because they are easier to wash. Other forms of dyes may also be used depending on the end use of the product, such dyes are Solvent Green 7 from Spectra Colors, Acid Red 1 from Rite Colors, Acid Black 2 from Spectra Colors, Acid Red 92, Acid Red Orange from Carolina Colors and FD&C Blue 1, Red 40, and Yellow 5 from Warner Jenkins on Colors. These dyes are used at a quantity of about 05% to about 5%, preferably about 1.0% to about 3.0%, most preferably about 1.5% by weight. This, however, depends on the desired color strength.

Fluorescent colors may be obtained by either using fluorescent dyes such as Solvent Green 7 and Red 15 or fluorescent pigments in the form of fluorescent emulsions such as Victorian Colors from Mikuni Color Works. These fluorescent emulsions are used at a range of about 10% to about 50%, preferably about 20% to about 40%, more preferably about 30% by weight.

The coloring compositions of the present invention may further comprise a dispersant, a release agent and/or alcohol or coalescent to improve drying speed.

Alcohols and/or coalescents can be used to improve drying speed and film formation. Care should be exercised however, since these chemicals can destroy the voids that contain air thereby allowing light to pass through and reducing or preventing the opaque effect.

The above ingredients are examples of what can be used to make this invention effective but in no way limits these formulations as one knowledgeable in the art will find ingredients that may be functionable for demonstration purposes.

### EXAMPLE 1

### Preparation of a Wet Erase/Dry Erase—White Coloring Composition

A Wet Erase/Dry Erase—White coloring composition was prepared using the following ingredients.

| Ingredient | % by Weight | Supplier |
|---|---|---|
| Water | 7.0 | Deionized |
| Diethylene Glycol | 15.0 | Pride Chemicals |
| Ropaque OP-96 | 75.0 | Rohm & Haas |
| DC-193 | 2.5 | Dow Corning |
| Zonyl FSO | 0.25 | DuPont |
| Proxel GXL | 0.25 | Avecia Biosides |
| | 100 | |

### EXAMPLE 2

### Preparation of a Permanent & Coloring—White Coloring Composition

A Permanent & Coloring—White coloring composition was prepared using the following ingredients.

| Ingredient | % by Weight | Supplier |
|---|---|---|
| Water | 8.60 | Deionized |
| Propylene Glycol | 5.0 | Pride Chemicals |
| Ropaque OP-96 | 75.0 | Rohm & Haas |
| Carboset GA1594 | 10.0 | BF Goodrich |
| DC-193 | 1.0 | Dow Corning |
| Zonyl FSO | 0.15 | DuPont |
| Proxel GXL | 0.25 | Avecia Biosides |
| | 100 | |

### EXAMPLE 3

### Preparation of a Dry Erase/Wet Erase/Coloring/Writing—Red Coloring Composition

A Dry Erase/Wet Erase/Coloring/Writing—Red coloring composition was prepared using the following ingredients.

| Ingredient | % by Weight | Supplier |
|---|---|---|
| Water | 15.50 | Deionized |
| Diethylene Glycol | 12.0 | Pride Chemicals |
| Ropaque OP-96 | 60.0 | Rohm & Haas |
| DC-193 | 2.0 | Dow Corning |
| Zonyl FSO | 0.25 | DuPont |
| Titicaca Red | 10.25 | Mikuni Color |
| | 100 | |

### EXAMPLE 3

### Preparation of a Washable Ink/Writing—Red Coloring Composition

A Washable Ink/Writing—Red coloring composition was prepared using the following ingredients.

| Ingredient | % by Weight | Supplier |
|---|---|---|
| Water | 19.75 | Deionized |
| Carbowax 400 | 15.0 | Pride Chemicals |
| Ropaque OP-96 | 60.0 | Rohm & Haas |
| DC-193 | 2.5 | Dow Corning |
| Zonyl FSO | 0.25 | DuPont |
| FD&C Red 40* | 2.5 | Warner Jenkinson |
| | 100 | |

*Polymeric dyes from Milliken known in the industry may be substituted for greater washability.

### EXAMPLE 4

### Preparation of a Dry Erase/Wet Erase/Coloring—Blue Coloring Composition

A Dry Erase/Wet Erase/Coloring—Blue coloring composition was prepared using the following ingredients.

| Ingredient | % by Weight | Supplier |
|---|---|---|
| Water | 17.25 | Deionized |
| Diethylene Glycol | 12.0 | Pride Chemicals |
| Ropaque OP-96 | 60.0 | Rohm & Haas |
| Suspense BHD-6015 | 8.0 | Sun Chemical |
| DC-193 | 2.5 | Dow Corning |
| Tergitol 15-S-7 | .25 | Union Carbide |
| | 100 | |

### EXAMPLE 5

### Preparation of a Washable Ink/Coloring/Writing—Blue Coloring Composition

A Washable Ink/Coloring/Writing—Blue coloring composition was prepared using the following ingredients.

| Ingredient | % by Weight | Supplier |
|---|---|---|
| Water | 27.95 | Deionized |
| Carbowax 400 | 20.0 | Pride Chemicals |
| Ropaque OP-96 | 50.0 | Rohm & Haas |
| Tergitol 15-S-7 | 0.15 | Union Carbide |
| Proxel GXL | 0.15 | Avecia Biosides |
| FD&C Blue 1 | 1.75 | Warner Jenkinson |
| | 100 | |

### EXAMPLE 6

### Preparation of a Dry Erase/Wet Erase/Coloring—Green Coloring Composition

A Dry Erase/Wet Erase/Coloring—Green coloring composition was prepared using the following ingredients.

| Ingredient | % by Weight | Supplier |
|---|---|---|
| Water | 27.75 | Deionized |
| Diethylene Glycol | 12.0 | Pride Chemicals |
| Ropaque OP-96 | 50.0 | Rohm & Haas |
| Titicaca Green | 10.0 | Mikuni |
| Zonyl FSO | 0.25 | DuPont |
| | 100 | |

### EXAMPLE 7

### Preparation of a Dry Erase/Wet Erase/Coloring/Writing Ink—Fluorescent Pink Coloring Composition

A Dry Erase/Wet Erase/Coloring/Writing Ink—Fluorescent Pink coloring composition was prepared using the following ingredients.

| Ingredient | % by Weight | Supplier |
|---|---|---|
| Water | 9.75 | Deionized |
| Diethylene Glycol | 10.0 | Pride Chemicals |
| Ropaque OP-96 | 45.0 | Rohm & Haas |
| Victoria Pink | 35.0 | Mikuni |
| Zonyl FSO | 0.25 | DuPont |
| | 100 | |

### EXAMPLE 8

### Preparation of a Dry Erase/Wet Erase/Coloring/Writing Ink—Violet Coloring Composition

A Dry Erase/Wet Erase/Coloring/Writing Ink—Violet coloring composition was prepared using the following ingredients.

| Ingredient | % by Weight | Supplier |
|---|---|---|
| Water | 15.25 | Deionized |
| Propylene Glycol | 12.0 | Pride Chemicals |
| Ropaque OP-96 | 60.0 | Rohm & Haas |
| DC-193 | 2.5 | Dow Corning |
| Titicaca Violet | 10 | Mikuni |
| Zonyl FSO | 0.25 | DuPont |
| | 100 | |

### EXAMPLE 9

### Preparation of a Dry Erase/Wet Erase/Coloring/Writing Ink—Fluorescent Orange Coloring Composition

A Dry Erase/Wet Erase/Coloring/Writing Ink—Fluorescent Orange coloring composition was prepared using the following ingredients.

| Ingredient | % by Weight | Supplier |
|---|---|---|
| Water | 7.25 | Deionized |
| Propylene Glycol | 10.0 | Pride Chemicals |
| Ropaque OP-96 | 40.0 | Rohm & Haas |
| DC-193 | 2.5 | Dow Corning |
| Victoria Orange | 40 | Mikuni |
| Zonyl FSO | 0.25 | DuPont |
| | 100 | |

### EXAMPLE 10

### Preparation of a Permanent Blue Ink Coloring Composition

A Permanent Blue Ink (Generic*) coloring composition was prepared using the following ingredients.
*Other colors can be made permanent by, substituting different colors in the Titicaca, Sunsperse and Flexiverse lines in this formula.

| Ingredient | % by Weight | Supplier |
|---|---|---|
| Water | 22.85 | Deionized |
| Carboset GA 1594 | 10.00 | BF Goodrich |
| Ethanol | 3.00 | Pride Chemicals |
| Propylene Glycol | 2.00 | Pride Chemicals |
| DC-193 | 2.00 | Dow Corning |
| Zonyl FSO | 0.15 | DuPont |
| Titicaca Blue | 10.00 | Mikuni |
| Ropaque OP-96 | 50.00 | Rohm & Haas |
| | 100 | |

### EXAMPLE 11

### Preparation of a Dry Erase/Wet Erase/Coloring/Writing Ink—Fluorescent Yellow Coloring Composition

A Dry Erase/Wet Erase/Coloring/Writing Ink—Fluorescent Yellow coloring composition was prepared using the following ingredients.

| Ingredient | % by Weight | Supplier |
|---|---|---|
| Water | 30.35 | Deionized |
| Sodium Carbonate | 2.0 | Pride Chemicals |
| Solvent Green 7 | 4.00 | Spectra Colors |
| Ropaque OP-96 | 60.0 | Rohm & Haas |
| DC-193 | 2.0 | Dow Corning |
| Tergitol 15-S-7 | 0.15 | Union Carbide |
| Triethanolamine | 1.50 | Pride Chemicals |
| | 100 | |

As described in the above examples, the present invention provides an opaque ink system for wick-style and/or free-ink system writing instruments. This system contains water as a carrier, a hollow microspheric emulsion as an opacifier, a dimethicone copolymer with multiple functions including, but not limited to, stability, suspending, release, detackification, lubrication, and humectancy. These formulations may contain colored pigments and/or colored dyes, a humectant, a surfactant or surfactants, and may also include a pH adjustor and preservative.

This writing instrument in the form of its invention, aims to satisfy a market for both light and dark surfaces with applications in writing, dry erase, wet erase, coloring, and crafting. Other uses may be established by the market if so desired. The ingredients listed in the examples can be varied by someone knowledgeable in the art for functionality and therefore should not be limited to the specific ingredients.

Although the present invention has been described in relation to particular embodiments thereof, many other variations and modifications and other uses will become apparent to those skilled in the art. The present invention therefore is not limited by the specific disclosure herein, but only by the appended claims.

1. A water-based opaque ink coloring composition suitable for use in markers comprising:
(a) a carrier comprising water;
(b) a dimethicone copolyol; and
(c) submicron polymeric particles having an outer polymeric shell which defines an inner hollow region,
wherein said composition does not contain a neutral buoyancy additive.

2. The water-based coloring composition of claim 1, wherein said submicron polymeric particles are modified with compounds selected from the group consisting of dyes, pigments, and mixtures thereof.

3. The water-based coloring composition of claim 1, wherein the inner hollow region of said submicron polymeric particles contains water.

4. The water-based coloring composition according to claim 1, wherein said submicron polymeric particles are microspheres.

5. The water-based coloring composition of claim 1, wherein said submicron polymeric particles are in the form of styrene/acrylic emulsion.

6. The water-based coloring composition of claim 1, wherein said submicron polymeric particles are present in an amount from about 5% by weight to about 80% by weight of the coloring composition.

7. The water-based coloring composition of claim 1, wherein said water is deionized water.

8. The water-based coloring composition of claim 1, wherein said water is present in an amount from about 3% by weight to about 50% by weight of the coloring composition.

9. The water-based coloring composition of claim 1, wherein said coloring composition has a density of about 8.0 lbs/gal to about 9.0 lbs/gal.

10. The water-based coloring composition of claim 7, wherein said coloring composition has a viscosity of from about 1 to about 20 centipoises.

11. The water-based coloring compositions according of claim 1, further comprising a colorant.

12. The water-based coloring compositions of claim 11, wherein said colorant is selected from the group consisting of dyes, pigments, and mixtures thereof.

13. The water-based coloring compositions of claim 1, further comprising a humectant.

14. The water-based coloring compositions of claim 13, wherein said humectant is a glycol.

15. The water-based coloring compositions of claim 1, further comprising a surfactant that serves to lower surface tension and provide flow.

16. The water-based coloring compositions of claim 15, wherein said surfactant is in the form of anionic, or non-ionic fluorocarbon.

17. The water-based coloring composition of claim 1, further comprising a dispersing agent.

18. The water-based coloring compositions of claim 1, further comprising a pH adjustor.

19. The water-based coloring compositions of claim 1, further comprising an alcohol or coalescent to improve drying speed.

20. The water-based coloring composition of claim 1, further comprising a release agent.

21. The water-based coloring composition of claim 1, wherein said dimethicone copolyol is DC-190.

22. The water-based coloring composition of claim 1, wherein said dimethicone copolyol is DC-193.

23. A marking instrument for applying an opaque ink coloring composition comprising a nib and a reservoir wherein said reservoir contains a water-based opaque ink coloring composition comprising:
(a) a carrier comprising water;
(b) a dimethicone copolyol; and
(c) submicron polymeric particles having an outer polymeric shell which defines an inner hollow region,
wherein said composition does not contain a neutral buoyancy additive.

24. The marking instrument of claim 21, wherein said water-based opaque ink coloring composition is in a filler material.

25. The marking instrument of claim 21, wherein said water-based opaque ink coloring composition is free and not in a filler material.
